(19) United States
(12) Patent Application Publication
(10) Pub. No.: US 2018/0040253 A1
(43) Pub. Date: Feb. 8, 2018

(54) Audio Choreography for Cognitive Impairment and Profound Physical Limitation

(71) Applicants: Paul Arthur Wulf, Naples, FL (US); Debra Ann Wulf, Naples, FL (US)

(72) Inventors: Paul Arthur Wulf, Naples, FL (US); Debra Ann Wulf, Naples, FL (US)

(21) Appl. No.: 15/227,907

(22) Filed: Aug. 3, 2016

(51) Int. Cl. G09B 5/04; G09B 19/00

(52) U.S. Cl. CPC G09B 5/04; G09B 19/003

(57) ABSTRACT

A method and process for directing and training special needs participants with cognitive or profound physical impairment to successfully perform activities of daily living. The method is comprised of easily understandable, functionally appropriate and incremental verbal prompts that seamlessly interface with segments of music providing auditory rhythmic cues that are associated and connected to the sequential steps of the task or activity creating an audio choreography that develops a conditioned set of physical responses with repeated use of the program.

### BACKGROUND OF THE INVENTION

### Field of the Invention

This invention relates to a method and process for instructing individuals with cognitive impairment or profound physical limitations to perform activities of daily living with a program that is specifically designed to address the limitations of special needs participants to comprehend, process and respond to directions as would be ordinarily anticipated within the prior art and the inability of their performance capacity to undergo any measurable advancement or even demonstrate the ability to adapt, improve, progress or grow. The differences needed for instruction and care of cognitively impaired individuals is exhaustive. If it were obvious to a person of ordinary skill to adapt or otherwise alter existing teaching techniques and methods there would be no need for “special” classrooms, “special” books, “special” teachers, “special” environments, or even “Special” Olympics. In each case it is an example of pre-determined and specific programming which addresses the chronically compromised ability to retain, absorb, grasp, recall and process basic directions and communications whereby development and progress toward independent proficiency is not a matter of adapting or adopting methods and programs used by non-cognitively impaired participants. Daily living skills are no exception to the specific and specialized programming required rather than the attempts to adapt, modify or assimilate programs used by other participants of the general population who exhibit the capacity to advance and progress in the performance of these tasks as is ordinarily anticipated with other instructional models and methods.

### Background of the Invention

Learning, retaining and proper utilization of daily living skills is one of the processes of a “normal” child's development. When that “normal” development is either impeded for some reason or never takes place, those individuals have little choice but to rely on a parent or caregiver to perform these tasks or activities. The problem is the constant battle against the inability for the cognitively impaired or physically limited individual to understand, retain or recognize instructions.

Although research going back to the late 1990's has indicated and supports a strong relationship that exists between music, cognition and functioning, there has been no proposed combination or modification to form a seamless instructional interface between music and instruction that can condition a prescribed behavior from cognitively or physically impaired participants:
Brotons, M., Koger, S. M., & Pickett-Cooper, P. (1997). Music and dementias: A review of literature. The Journal of Music Therapy, 34(4), 204-245.
Crystal, H., Grober, E., & Masur, D. (1989). Preservation of musical memory in Alzheimer's disease. Journal of Neurology, Neurosurgery, and Psychiatry, 52(12), 1415-1416.
Guétin, S., Portet, F., Picot, M. C., Pommié, C., Messaoudi, M., Djabelkir, L., Olsen, A. L., Cano, M. M., Lecourt, E., & Touchon, J. (2009). Effect of music therapy on anxiety and depression in patients with Alzheimer's type dementia: randomized, controlled study. Dementia and Geriatric Cognitive Disorders, 28(1), 36-46.
Koger, S. M., Chapin, K., & Brotons, M. (1999). Is music therapy an effective intervention for dementia? A meta-analytic review of literature. The Journal of Music Therapy, 36(1), 2-15.
Svansdottir, H. B., & Snaedal, J. (2006). Music therapy in moderate and severe dementia of Alzheimer's type: a case-control study. International Psychogeriatric Association, 18(4), 613-21.
Raglio, A., Bellelli, G., Traficante, D., Gianotti, M., Ubezio, M. C., Villani, D., & Trabucchi, M. (2008). Efficacy of music therapy in the treatment of behavioral and psychiatric symptoms of dementia. Alzheimer disease and associated disorders, 22(2), 158-162.

From this sampling of the research into cognition impairment and profound physical limitation it can be demonstrated that music can stimulate positive interaction, facilitate cognitive function and coordinate motor movements. Individuals who are impacted with any of the more than 70 types of dementia will have a significant loss of function within the left hemisphere of the brain impacting memory, visual recognition, speech and coordination, but may suffer little to no difference in the right hemisphere of the brain impacting music and other creative processes. The goal of this invention is to draw upon the unaffected portion of the brain or right hemisphere with music to establish a neurological link between a specific segment of music with a repetitive and conditioned physical response because rhythmic and other well-rehearsed responses require little to no cognitive or mental processing.

### DESCRIPTION OF THE RELATED ART

The prior art of instructional methods, devices or processes fails to address limitations faced by those with cognitive impairment or profound physical limitations with a uniquely designed program that incorporates a previously un-suggested combination of verbal prompts with a musical accompaniment that is a previously un-proposed modification as an auditory rhythmic cue rather than merely providing background environment. This is prevalent throughout the types of prior art currently available including the following:

The first type of prior art offers instruction and reinforcement to the child participants while they are executing particular hygiene tasks. One example of such a system is U.S. Pat. No. 6,037,871 to Babylon; this system includes various sensors throughout the bathroom and on various fixtures like the toilet, a bench that steps up to the toilet, the wash basin, sink and soap dish. These sensors detect movement and initiate a playback of encouragement on the current bathroom task and a reminder of what is the next task as in a handle depressed on the toilet signaling the completion of that phase of use initiates a playback device that compliments the participant on that step and a reminder to wash next. It does not interface with music as an auditory rhythmic cue with the verbal prompts nor are the directions divided incrementally in a fashion that would accommodate an individual with cognitive impairment or profound physical limitations.

Another type of prior art offers feedback or additional instruction after a participant has completed a hygiene task. An example of this type of product is U.S. Pat. Publication No. 2005/0239029 A1 to Yzermans et al.; this system includes the use of a prerecorded message for toilet training whereby a participant can use a phone or internet to gain access to this message which can be used by either a caregiver or participant. There can be several messages used for a single hygiene task as in the case of toilet training and additional embodiments can include apparel with illustrations associated with the prerecorded messages regarding a single or multiple hygiene tasks. Unfortunately, this is another example how the un-proposed combination of music as an auditory rhythmic cue with verbal prompts restricts the participation of someone with cognitive impairment or profound physical limitations.

Further examples of the un-proposed combination of verbal prompts with music utilized as an un-suggested modification from background usage to auditory rhythmic cueing within the prior art includes instructions to a caregiver or adult with directions on how to instruct a young participant through good habits and activities. An example of this type of product is U.S. Pat. Publication No. 2004/0018474 to D'Ippolito; this system includes directions for an adult to convey life experiences and habits to a child. The system includes exercises and activities for the participant and supervised by the adult with workbooks, videos, prerecorded messages and computer software. U.S. Pat. No. 6,250,929 to Kolb provides a method for improving the effectiveness of toilet training using a progress scale with questions regarding toilet training learned skills with response values to evaluate levels of toilet training with recommendations for improving the effectiveness of the training based on the skill. U.S. Pat. No. 6,203,327 to Ottrando shows a toilet training system using a board with a pre-printed path made up of step spaces and reward goal spaces with removable marks made on the board to indicate progress for each mark and setbacks by removing marks. U.S. Pat. No. 5,725,382 to Walter claims a self-contained interactive toilet training kit for children and caregivers that include training pants, interactive devices and activity devices for encouraging the child in toilet training. U.S. Pat. No. 5,387,107 to Gunter describes a personalized interactive storybook and method of teaching a reader a desired behavior pattern with text referring to the desired behavior and illustrations, which may be modified to include a picture of the child, related to the carrying out of the desired behavior. U.S. Pat. No. 2,946,137 to Worth discloses a child's story book with shift-able pictures using cut-out stickers that a child can place in different positions and on different pages in the book. U.S. Pat. No. 5,577,915 to Feldman indicates a motivational task tracking device that organizes activities into categories and provides a graphic incentive system for their performance with cards representing activities placed on a chart to indicate progress. U.S. Pat. No. 5,951,298 to Werzberger puts forth an interactive coordinated book assembly with pages having instructions for activities with a key word or image related to the life experiences and good habits and activities and knowledge and using a visual image associated with each activity and a code to indicate age of competency level.

Then there are systems and methods that have been developed to assist with learning disabilities. For example, U.S. Pat. No. 4,695,257 to Vawter; U.S. Pat. No. 5,336,093 to Cox; U.S. Pat. No. 5,135,398 to Thornton et al.; U.S. Pat. No. 5,256,067 to Gildea et al.; and U.S. Pat. No. 5,316,485 to Hirose are examples of such systems. These systems and methods are intended to assist in teaching reading, writing, and mathematics. A typical approach with these types of systems and methods is to incorporate conventional classroom techniques into a game or a computer program. These conventional teaching methods have already proven to be ineffective in reaching individuals with cognitive impairment or profound physical limitations. There are also systems and methods for children that include a musical component. For example, U.S. Pat. No. 5,259,086 to Fong and U.S. Pat. No. 4,285,151 to Gertter are indicative of such systems or apparatus that are intended to assist with various hygiene tasks utilizing a musical component. The musical feature is unfortunately of a background nature with no impact on participant functioning. These illustrations from the prior art also fail as specifically engineered and designed teaching and instructional programs for those with cognitive impairment or profound physical limitations. They demonstrate the necessity for an un-suggested combination of verbal prompt with the un-proposed modification of music as an auditory rhythmic cue rather than background environment. It also fails to address the measured pauses that allow sufficient time for participants of diminished capacity to complete the verbal prompt with an auditory rhythmic cue and the utilization of terms and expressions that are intentionally selected due to the appropriate level of understanding and communicating necessary for participants of diminished capacity while also failing to divide specific tasks or activities into small enough increments that would be readily understandable and attainable for anyone with a cognitive impairment or profound physical limitation.

As evidenced by the preceding paragraphs there is a plethora of prior art available to assist caregivers and children in the development of daily living skills ranging from training guides to instructional materials. There is no design element in these systems that is based on evaluations regarding the ability of the participant to progress or advance; the appropriateness of the instructions as it relates to someone of lower cognitive reasoning, understanding and recognition of common objects, terms or directions and most significantly does not incorporate music as an integral part of the actual instruction process or, as indicated herein, an auditory rhythmic cue. The significant differences of capacity, functioning capability, cognitive reasoning, potential for cognitive retention and performance advancement renders the existing products, systems or methods inconsistent with the needs presented by those with cognitive impairment or profound physical limitations as evidenced by the research.

Therefore, a need exists for a system and method that is specifically designed and engineered for cognitively impaired individuals and isn't merely a matter of design choice or adaptation to anyone of ordinary skill in the art. Although the prior art endeavors to offer direction and instruction through various means and devices it falls short when addressing the limitations faced by participants with special needs with programming that is needed that offers a seamless interface between music and incremental steps of the instructions for task or activity completion. The prior art that does include musical elements is of a background nature and not used as auditory rhythmic cues that can stimulate the necessary physical motor responses to complete the designated task or activity.

### SUMMARY OF THE INVENTION

This invention addresses the limitations that are common to individuals with cognitive impairments or profound physical limitations which prohibits them from remembering the necessary instructions along with the associated physical responses that would enable them to perform basic activities of daily living. It differs from any prior invention in that specific musical interludes are interfaced with specific portions of the instructions sparking an outcome that is based on a predictable and acceptable range of behavior stimulated by the auditory rhythmic cues of the musical interface and conditioned by repeated use and rehearsal. This conditioned response will enable preferred accommodation for a participant who will not advance in proficiency nor retain or anticipate directions with further or continued use. This unique approach utilizing music as a cueing mechanism interfaced with highly detailed and incremental direction that is measured and issued in a much smaller graduated rate than what would be expected or anticipated by someone of ordinary skill who is not intimately acquainted with the particular obstacles, challenges and hindrances encountered by an individual with cognitive impairment or profound physical limitations allows the participant with diminished capacity to perform daily living skills with a much higher degree of proficiency and effectiveness.

### BRIEF DESCRIPTION OF THE DRAWING

FIG. 1 is an illustration of Audio Choreography and represents the use of auditory rhythmic cueing along with its companion verbal prompt in the form of a sound wave to accomplish a specific task, activity or purpose.

Step 1-A: Verbal Prompt. The first pre-recorded incremental step of the task, activity or purpose is issued as a verbal prompt at a high auditory volume comprising a decibel level between 70-85 dB.

Step 1-B: Musical Accompaniment. While the first pre-recorded incremental step of the task, activity or purpose is being issued at 70-85 decibels a specifically selected musical accompaniment is playing as a background environment at a low auditory volume comprising a decibel level between 25-40 dB.

Step 1-C: Transition 1. A volume transition occurs when the first pre-recorded incremental step of the task, activity or purpose described in step 1-A concludes. The specifically selected musical accompaniment of step 1-B that was playing at a low auditory volume comprising a decibel level between 25-40 dB immediately increases to a high auditory volume comprising a decibel level between 70-85 dB.

Step 1-D: Auditory Rhythmic Cue. Upon completion of the instantaneous transition of step 1-C, a pre-selected and easily recognizable portion of the musical accompaniment of step 1-B is seamlessly interfaced with the verbal prompt comprising the first pre-recorded incremental step of the task, activity or purpose from step 1-A. This seamless interface creates a neurological link between the verbal prompt of step 1-A and the auditory rhythmic cue from this portion of the musical accompaniment connected or bonded to it.

Step 1-E: Transition 2. A second volume transition associated to this verbal prompt/auditory rhythmic cue combination occurs following a measured and sufficient amount of time that allows the participant to complete the incremental step given as a verbal prompt in step 1-A. The musical accompaniment decreases to its pre-auditory rhythmic cue level of volume at an auditory range of 25-40 decibels and is again at the auditory level of a background environment to accommodate the next pre-recorded incremental step of the task, activity or purpose.

Step 2-A: Verbal Prompt. The second pre-recorded incremental step of the task, activity or purpose is issued as a verbal prompt at a high auditory volume comprising a decibel level between 70-85 dB.

Step 2-B: Musical Accompaniment. While the second pre-recorded incremental step of the task, activity or purpose is being issued at 70-85 decibels the specifically selected musical accompaniment from step 1-B continues playing as a background environment at a low auditory volume comprising a decibel level between 25-40 dB.

Step 2-C: Transition 1. A volume transition occurs when the second pre-recorded incremental step of the task, activity or purpose from step 2-A concludes. The specifically selected musical accompaniment of step 2-B that was playing at a low auditory volume comprising a decibel level between 25-40 dB immediately increases to a high auditory volume comprising a decibel level between 70-85 dB.

Step 2-D: Auditory Rhythmic Cue. Upon completion of the instantaneous transition of step 2-C, the pre-selected and easily recognizable portion of the musical accompaniment from step 2-B is seamlessly interfaced with the verbal prompt comprising the second pre-recorded incremental step of the task, activity or purpose from step 2-A. This seamless interface creates a neurological link between the verbal prompt of step 2-A and the auditory rhythmic cue from this portion of the musical accompaniment connected or bonded to it.

Step 2-E: Transition 2. A second volume transition associated to this verbal prompt/auditory rhythmic cue combination occurs following another measured and sufficient amount of time that allows the participant to complete the incremental step given as a pre-recorded verbal prompt in step 2-A. The musical accompaniment decreases to its pre-auditory rhythmic cue level of volume at an auditory range of 25-40 decibels and is again at the auditory level of a background environment to accommodate the next pre-recorded incremental step of the task, activity or purpose.

The process continues with this established pattern:
1. Verbal prompt with musical accompaniment background.
2. First transition when verbal prompt concludes and volume of musical accompaniment increases.
3. Musical accompaniment is linked to verbal prompt as an auditory rhythmic cue.
4. Second transition when volume of musical accompaniment decreases following the completion of the incremental step of the particular verbal prompt and auditory rhythmic cue combination.

These combinations of verbal prompts and auditory rhythmic cues comprising a specific incremental portion of the particular task, activity or purpose proceed in a distinct and sequential order so that when each of these incremental steps have been completed it results in the culmination of the entire task, activity or purpose.

### BRIEF DESCRIPTION OF THE PREFERRED EMBODIMENT

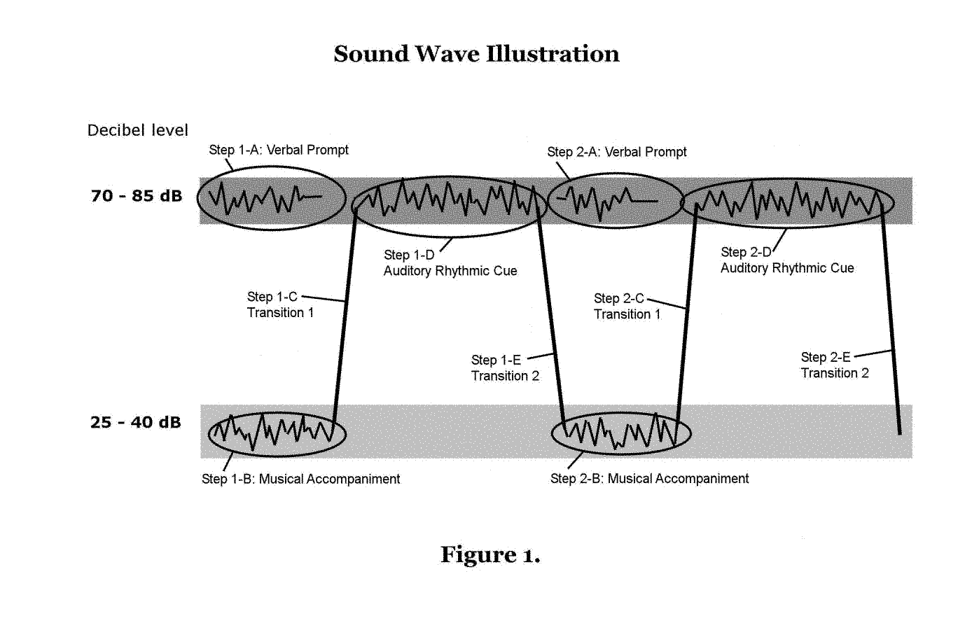

In the preceding discussion of the prior art and available inventions, in particular its lack of proposed alterations, adaptations, modifications or combinations to adequately address the specific needs, issues and challenges concerning the effective instruction and teaching of daily living skills to cognitively impaired or profoundly physically limited individuals, presents a void that this invention fills by providing a system and method that is intentionally constructed for efficacious application to participants with compromised physical or cognitive ability. This is accomplished by providing the participants with prerecorded directions of specific tasks, activities or purpose interfaced with music that provides them with auditory rhythmic cues for each incremental step of the task, activity or purpose. This embodiment provides for an adult caregiver of reasonable skill to facilitate the audio playback with adequate volume of the system and method for the cognitively or physically impaired participant. The directions are presented with terms and expressions of simple structure for ease of understanding in short, concise segments that are interfaced with a portion of music of comparable decibel level. The continuity of the decibel level between verbal prompts and the music comprising the auditory rhythmic cues is crucial and one of the distinctive features of this invention. The process toward task, activity or purpose completion is accomplished by the participant continuing to perform the verbal command with its associated auditory rhythmic cue for each successive step of the task, activity or purpose. The entire task, activity or purpose has been divided into small incremental segments, each being explained in easily understood terms and phrases and each being connected to a segment of the musical interface. Sufficient time is allotted for each step of the task, activity or purpose to enable someone of compromised comprehension or physical limitation to complete that step. Each direction is repeated numerous times, using the identical words in the precise order with each repetition of command so as not to confuse the participant. The instructions proceed in a sequential order and interfaced with the auditory rhythmic cues as would be necessary to complete the specific daily living skill as shown in the sound wave model of FIG. 1. This unique method that is based on research indicating how music can stimulate positive interaction and coordinate motor movements is the first to deviate from conventional and existing systems and methods within the prior art by a previously un-proposed combining or pre-recorded verbal instruction with pre-recorded musical accompaniment that forms an unprecedented and efficacious alteration for use by physically or cognitively impaired participants.

1. A method utilizing a previously un-proposed combination of elements within the prior art comprising prerecorded instruction with musical accompaniment that forms a unique modification for training cognitively or profoundly physically impaired individuals that is accomplished by: issuing incremental steps for a specific task, activity or purpose of said prerecorded instruction, a series of measured pauses of sufficient duration accommodating the participant's diminished cognitive or physical functioning of said prerecorded instruction, a selection of music that is of similar duration as the specific task, activity or purpose playing in conjunction with said prerecorded instruction and utilizing alternating levels of volume between verbal prompts and musical accompaniment, a series of verbal prompts that are of easily recognizable terms and expressions to be more readily understood by participants of diminished capacity with alternating levels of volume between musical accompaniment and the verbal prompts of said prerecorded instruction, a complete set of incremental steps allowing a specific task, activity or purpose to be conducted sequentially from start to completion by participants of diminished cognitive or physical limitation of said prerecorded instruction.

2. The method of claim 1 wherein the modification of the prior art's auditory instruction is accomplished using a specifically selected segment of music that is intentionally connected or bonded to a specific portion of the verbal prompt or incremental step of the task, activity or purpose and this bonding by repetitious conditioning between the incremental step of the task, activity or purpose and the segment of music forms a neurological link for a combined set of direction of said prerecorded instruction.

3. The method of claim 1 wherein the modification of the prior art's musical accompaniment is accomplished by selecting specific portions of the musical accompaniment that are easily recognizable and identifiable and bonding or connecting them to a particular portion of the verbal prompt forming the said neurological link that triggers and initiates a desired physical motor response from the cognitively impaired or profoundly physically limited participants to perform that portion of the task, activity or purpose within an acceptable range of functionality and is now initiated by virtue of said neurological link forming an auditory rhythmic cue eliciting the desired physical response from the participants with cognitive impairment or profound physical limitations when the set consisting of verbal prompt with connected segment of musical accompaniment are heard from the said prerecorded instruction.

4. The method of claim 3 further comprising a previously un-proposed combination of verbal prompts detailing specific portions of a particular task, activity or purpose with an equally specific and easily identifiable portion of music as an auditory rhythmic cue that is neurologically linked to the verbal prompt which is accomplished by alternating the verbal prompt with the portion of music at a specific and predetermined decibel level of 70-85 decibels when that alternating segment whether verbal prompt or auditory rhythmic cue is the featured element of said prerecorded instruction and the reduced decibel level of 25-40 decibels during the measured pauses and intervals of said prerecorded instruction.

5. The method of claim 1 wherein the modification of prior art auditory instruction is accomplished using measured pauses and intervals between each verbal prompt with its corresponding portion of music as an auditory rhythmic cue that is neurologically linked to said verbal prompt allowing a sufficient length of time that would enable participation by individuals with impaired cognition and compromised physical functioning of said prerecorded instruction.

6. The method of claim 1 wherein the incremental steps comprising the complete set of steps for the specific task, activity or purpose is accomplished by dividing the specific task, activity or purpose into minute sub-commands that encompass the entire task, activity or purpose of said prerecorded instruction.
